(19) United States
(12) Patent Application Publication
(10) Pub. No.: US 2023/0262041 A1
(43) Pub. Date: Aug. 17, 2023

(54) TECHNOLOGIES FOR PERFORMING SOCIAL VERIFICATION OF USER IDENTITIES

(71) Applicant: Handzin, Inc., San Francisco, CA (US)

(72) Inventors: Henry James Gooden, Unley (AU); Michael John Galvin, San Francisco, CA (US); Brian McGill Isaac, San Francisco, CA (US)

(21) Appl. No.: 18/164,675

(22) Filed: Feb. 6, 2023

Related U.S. Application Data
(60) Provisional application No. 63/311,172, filed on Feb. 17, 2022.

(51) Int. Cl. H04L 9/40; H04L 65/403

(52) U.S. Cl. CPC H04L 63/08; H04L 65/403

(57) ABSTRACT

Technologies for verifying user identities include a device having circuitry configured to determine whether a compute device of a user has requested to join a communication session hosted on a computer network based communication platform. The circuitry is also configured to perform a primary verification operation to verify an identity of the user. Additionally, the circuitry is configured to determine whether a social verification of the identity of the user, based on a human analysis of one or more exhibited characteristics of the user, is warranted, request, in response to a determination that social verification of the identity of the user is warranted and from a member of the communication platform, confirmation of the identity of the user, and weight the confirmation of the identity of the user as a function of trust data indicative of how the member knows the user.

### CROSS-REFERENCE TO RELATED APPLICATIONS

The present application claims the benefit of U.S. Provisional Pat. Application No. 63/311,172, filed Feb. 17, 2022.

### BACKGROUND

Communication of information among individuals through a computer network based system can provide advantages over in-person meetings. Some computer network based systems enable real time or near real time audio and visual communication, and as such, approximate the synchronous and information-rich (e.g., changes in vocal tone, body language, etc.) qualities of in-person meetings. Accordingly, participants in a computer network based communication session (e.g., a video conference) may avoid the expense of physically traveling to a meeting location while still obtaining many of the benefits that would be afforded by meeting in person. Relatedly, such systems enable users to communicate in real time without the concern of spreading communicable diseases to each other.

While computer network based communication systems provide cost efficiencies, improvements in physical safety, and convenience over in-person meetings, there are also challenges that are introduced through the use of such systems. As an example, it is more difficult to confirm that a person participating in a communication is who the person claims to be. That is, given that computer network based communication systems may enable a user to participate from any geographic location and participate in a discussion merely by providing a set of login credentials associated with an account registered with the system, there may be a heightened risk of a person masquerading as another user. As such, valuable or sensitive information may be conveyed by one or more users of the network based communication system to a person under the incorrect conclusion that the person is someone else.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for performing social verification of user identities for a computer network based communication platform;

FIG. 2 is a simplified block diagram of at least one embodiment of a compute device of the system of FIG. 1;

FIGS. 3-5 are simplified block diagrams of at least one embodiment of a method for performing social verification of user identities that may be executed by the system of FIG. 1; and

FIGS. 6-8 are embodiments of user interfaces that may be produced by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

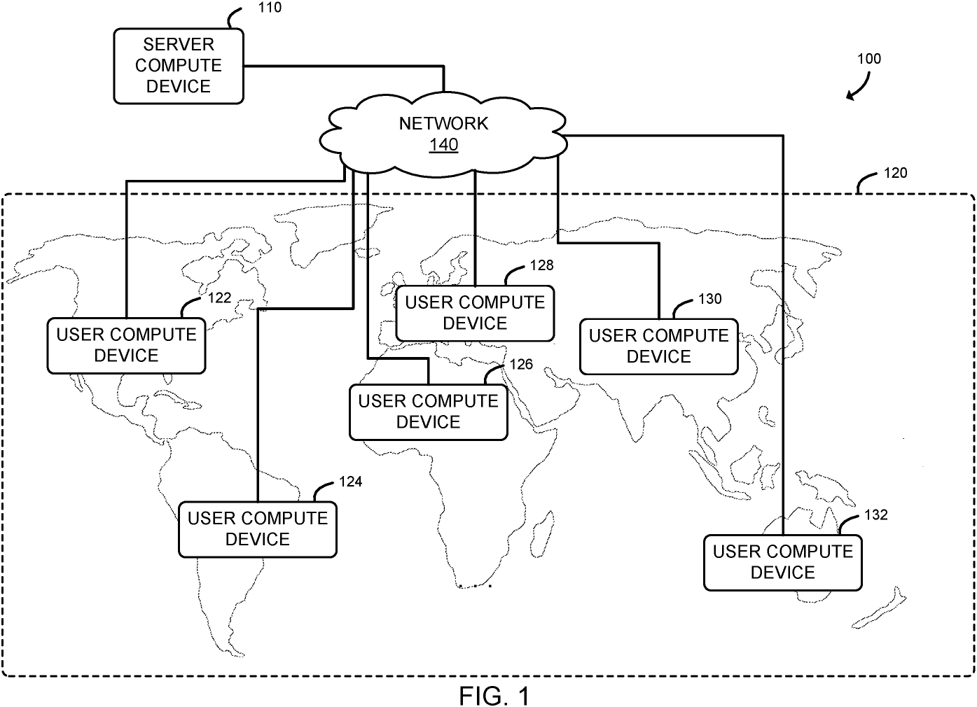

Referring now to FIG. 1, a system 100 for performing social verification of user identities for a computer network based communication platform includes, in the illustrative embodiment, a server compute device 110 (e.g., a rack-mounted server, a blade server, a desktop computer, etc.) in communication with user compute devices 120 (e.g., each a desktop computer, laptop computer, tablet computer, notebook, netbook, cellular phone, smartphone, personal digital assistant, mobile Internet device, wearable computing device, hybrid device, and/or any other compute/communication device). While only six user compute devices 122, 124, 126, 128, 130, 132 are shown in FIG. 1, it should be understood that, in practice, the number of user compute devices 120 may differ (e.g., tens, hundreds, thousands, or more user compute devices 120). Similarly, while only one server compute device 110 is shown in FIG. 1 for clarity of illustration, in some embodiments the system 100 may include multiple server compute devices and/or may include virtualized components of one or more compute devices (e.g., in a cloud data center) communicatively coupled to operate as the server compute device 110. In operation, the system 100 provides a computer network based communication platform (also referred to herein simply as a “platform”), implemented through the server compute device 110 (e.g., executing computer-readable instructions (e.g., code) at the server compute device 110) and the user compute devices 120 (e.g., executing code at the user compute devices 120, such as JavaScript and/or hyper-text markup language (HTML) in a web browser interface, interpreted or compiled code in a native software application, etc.) that enables users to communicate with each other (e.g., using video conferences, discussion threads, file sharing, and messages).

In the illustrative embodiment, the system 100, in operation, verifies the identity of a user who has joined a communication session (e.g., a video conference) among multiple members of the platform (e.g., users of the compute devices 120). The system 100, in the illustrative embodiment, is configured to determine whether the joining user has logged into the system 100 under circumstances (e.g., joining from a different device than the joining user typically uses, from a different region of the world than the joining user typically joins from, with video turned off, with audio turned off, etc.) that would warrant further verification of the joining user’s identity. The further verification, in some embodiments, includes requesting that other users (e.g., members of the platform) in the communication session confirm that the joining user is who the joining user claims to be (e.g., who the user is logged in as). In some embodiments, and as described in more detail herein, the system 100 may present a set of questions on the other members’ screens (e.g., the compute devices 120) to obtain a confirmation that the joining user is who he/she claims to be and to determine how each member knows the joining user. In doing so, the system 100 may take into account a variety of factors indicative of how well a member knows the other user to selectively increase or decrease a weight assigned to that particular member’s confirmation of the other user’s identity. In doing so, in some embodiments, the system 100 may give more weight to a member’s confirmation of another user’s identity if the confirming member indicates that he or she has met the user physically, rather than merely meeting virtually. Additionally or alternatively, the number of times the two users (e.g., a member and the user) have interacted with each other on the platform implemented by system 100 may influence the amount of weight given to the confirmation of the user’s identity.

In some embodiments, the system 100 may record a short sample (e.g., five to ten seconds) of video and/or audio of a user speaking and send the sample to members of the platform who have previously indicated that they know the user (e.g., with high interaction rates, in-person interactions, etc.), and prompt them to confirm that the user is indeed who he/she claims to be. Those members need not be in the same communication session with the user. That is, the system 100 may send the sample to the member(s) via email, a push notification, or another other communication channel to enable the corresponding member to observe the recorded sample and confirm or reject the purported identity of the user. In any of the above embodiments, if the identity of a user is not satisfactorily verified by the member(s) of the platform, the system 100 may take protective action(s), such as limiting one or more features of the user’s account, removing the user from a communication session, and/or signaling to members of the platform that the user’s identity is in question.

The system 100 may store trust data, which may be any data indicative of how members know each other, in a data structure, such as a matrix (a “trust matrix”). Once the system 100 has obtained trust data, the system 100 may incorporate that information into the identity verification process. In doing so, in some embodiments, the system 100 may assign a corresponding amount of weight to a member’s verification of a user’s identity without asking again how the member knows the user. Additionally or alternatively, the system 100 may utilize the trust data to identify a target recipient for a sample of a user’s speech and/or video for verification of the user’s identity. Each member may be assigned an adjustable trust score indicating how trusted that member is within the communication platform provided by the system 100. A member may initially have a default trust score upon registering with the system 100 and may build up their trust score through repeated interactions with other members of the system 100 that have high trust scores. In some embodiments, a visual indication of each member’s trust score may be presented to other members (e.g., as a badge or icon associated with the members) to help each member decide how they will interact with (e.g., how confident they can be in the identities of) other members. By utilizing user identity confirmations provided by people known by the system 100 to be familiar with a particular user, including people who are likely to be familiar with idiosyncratic speech patterns, voice inflections, body language, gestures, or other behavioral or physical characteristics of a user whose identity is in question, the system 100 provides a layer of user identity verification that is not present in conventional computer network based communication platforms and reduces the risk of a user masquerading as someone else.

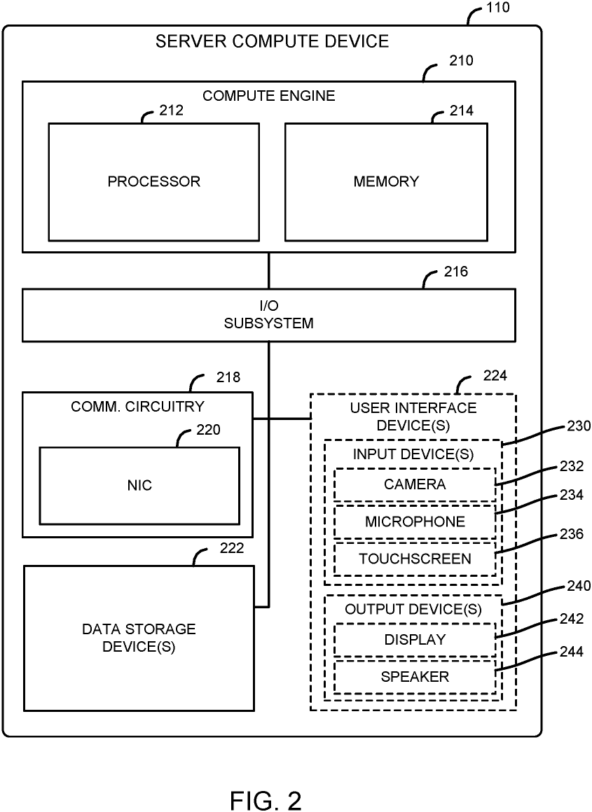

Referring now to FIG. 2, the illustrative server compute device 110 includes a compute engine 210, an input/output (I/O) subsystem 216, communication circuitry 218, and data storage subsystem 222. In some embodiments, the server compute device 110 may additionally include one or more user interface devices 224. Of course, in other embodiments, the server compute device 110 may include other or additional components. Additionally, in some embodiments, one or more of the illustrative components may be incorporated in, or otherwise form a portion of, another component.

The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such trust data indicative of how members of the platform know each other, account authentication credentials (e.g., user names, passwords, etc.), audio data indicative of audio associated with one or more communication sessions, video data indicative of video associated with one or more communication sessions, text and/or other data associated with conversation threads, applications, libraries, and drivers.

The compute engine 210 is communicatively coupled to other components of the server compute device 110 via the I/O subsystem 216, which may be embodied as circuitry and/or components to facilitate input/output operations with the compute engine 210 (e.g., with the processor 212 and the main memory 214) and other components of the server compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the server compute device 110, into the compute engine 210.

The communication circuitry 218 may be embodied as any communication circuit, device, or collection thereof, capable of enabling communications over a network between the server compute device 110 and another device (e.g., the user compute devices 120). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the server compute device 110 to connect with another compute device (e.g., the user compute devices 120). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the server compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

In some embodiments, the server compute device 110 includes one or more user interface devices 224, such as one or more input devices 230 and/or one or more output devices 240. As non-limiting examples, the one or more input devices 230 may include a camera 232 (e.g., a charge coupled device (CCD) or complementary metal-oxide-semiconductor (CMOS) image sensor coupled with a lens to focus received light and a shutter to control the amount of light received by the image sensor and circuitry to convert the received light to pixel data defining intensities of component colors for each spatial location in an image or a series of images), a microphone 234 (e.g., any device configured to convert acoustic waves to electrical signals), and/or a touchscreen 236 (e.g., any suitable touchscreen input technology to detect the user’s tactile selection of information displayed on a display including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors). The one or more output devices 240 may include, a display 242 (e.g., any suitable display technology including, for example, a liquid crystal display (LCD), a light emitting diode (LED) display, a cathode ray tube (CRT) display, a plasma display, and/or other display usable in a compute device), which may be integrated with the touchscreen 236 in some embodiments, and/or a speaker 244 (e.g., any device configured to convert electrical signals defining a waveform to corresponding acoustic waves).

While shown as a single unit, it should be appreciated that the components of the server compute device 110 may, in some embodiments, be distributed across multiple physical locations (e.g., multiple racks in a data center). Further, one or more of the components may be virtualized (e.g., in a virtual machine executing on one or more physical compute devices).

The user compute devices 120 may have components similar to those described in FIG. 2 with reference to the server compute device 110. The description of those components of the server compute device 110 is equally applicable to the description of components of the user compute devices 120. Further, it should be appreciated that any of the devices 110 and 120 may include other components, sub-components, and devices commonly found in a computing device, which are not discussed above in reference to the server compute device 110 and not discussed herein for clarity of the description.

In the illustrative embodiment, the server compute device 110 and the user compute devices 120 are in communication via a network 140, which may be embodied as any type of wired or wireless communication network, including global networks (e.g., the internet), local area networks (LANs) or wide area networks (WANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

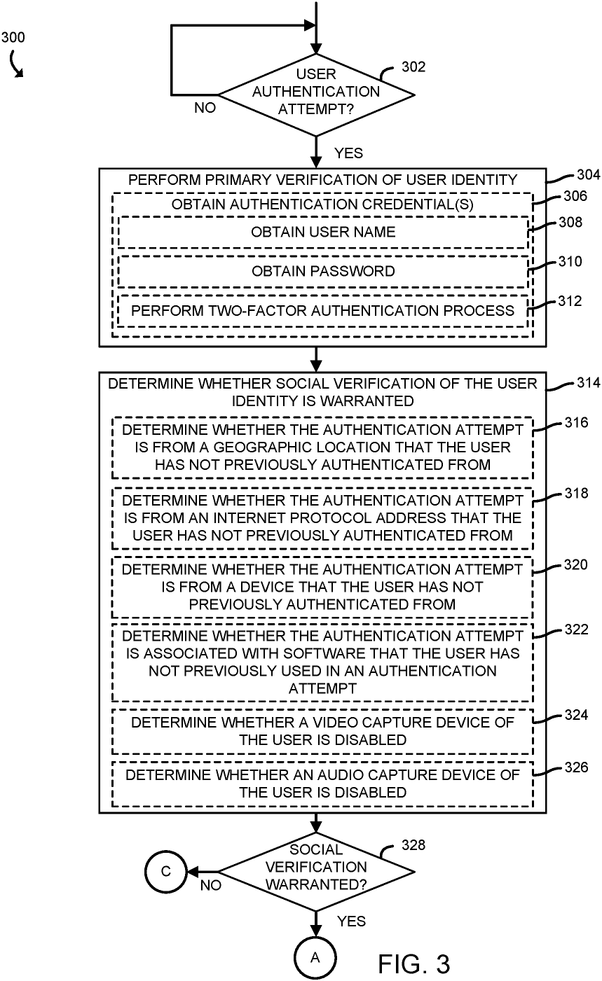

Referring now to FIG. 3, the system 100, in the illustrative embodiment, may execute a method 300 for performing social verification (e.g., confirmation) of user identities. The method 300 is described herein as being performed by the server compute device 110. However, it should be understood that it is within the scope of the disclosure that one or more of the user compute devices 120 may execute at least a portion of the method 300 (e.g., by executing code at the user compute device 120 to display a user interface according to data sent from the server compute device 110, to enable a camera and microphone to receive video and audio from a user of a corresponding user compute device 120, to receive other input from a user, etc.). The method 300 begins with block 302, in which the server compute device 110 may determine whether a user authentication attempt has been detected. The server compute device 110 may detect a user authentication attempt in response to a corresponding user compute device 120 submitting a request to authenticate to the system 100 (e.g., to a communication platform provided by the system 100, such as through a login user interface). In response to detecting a user authentication attempt, the method 300 advances to block 304 in which the server compute device 110 performs primary verification of the user identity. In doing so, and as indicated in block 306, the server compute device 110, in the illustrative embodiment, obtains authentication credentials. The authentication credentials may include a user name, as indicated in block 308 and a password, as indicated in block 310.

In some embodiments, as indicated in block 312, the server compute device 110 may additionally perform a two-factor authentication process in which the server compute device 110 receives, on behalf of the user attempting to authenticate, a credential from a separate source, such as a code sent (e.g., by the server compute device 110) to another device operated by the user (e.g., a text message sent to a cellular phone of the user), a cryptographic code generated by a device operated by the user, based on a key provided by the server compute device 110 at a previous time, and/or other credential(s) other than the user name and password combination of blocks 308 and 310.

After the server compute device 110 has performed primary verification of the user identity (e.g., by determining that the obtained authentication credentials match a set of reference credentials (e.g., in the memory 204 and/or data storage 222)), the method 300 advances to block 314 in which the server compute device 110 determines whether social verification (e.g., confirmation by a threshold number of members) of the user identity is warranted. In doing so, and as indicated in block 316, the server compute device 110 may determine whether the authentication attempt is from a geographic location that the user has not previously authenticated from. For example, the server compute device 110 may compare an internet protocol (IP) address associated with one or more communications sent from the user compute device 120 associated with the authentication attempt to a database that correlates internet protocol addresses with geographic regions, determine the geographic region associated with the internet protocol address, and determine whether the geographic region matches a geographic region in a data set of geographic regions from which the user has previously authenticated to the system 100. Relatedly, and as indicated in block 318, the server compute device 110 may determine whether the authentication attempt is from an IP address that the user has not previously authenticated to the system 100 from (e.g., by comparing the present IP address associated with the authentication attempt to previous IP addresses associated with the authentication credentials (e.g., associated with the user account)).

As indicated in block 320, in determining whether social verification of the user identity is warranted, the server compute device 110 may determine whether the authentication attempt is from a device that the user has not previously authenticated from. For example, the server compute device 110 may obtain, from a communication sent by the corresponding user compute device 120, a unique identifier (e.g., a media access control address) associated with the user compute device 120 and determine whether the obtained unique identifier is present in a data set (e.g., in the memory 204 and/or the data storage 222) of previous unique identifiers of user compute device(s) 120 used in connection with the user account. In some embodiments, and as indicated in block 322, the server compute device 110 may determine whether the authentication attempt is associated with software that the user has not previously used in an authentication attempt (e.g., by comparing a software identifier, such as a user agent string or similar data indicative of a web browser or other software executed by the corresponding user compute device 120 to communicate with the server compute device 110 with a data set (e.g., in the memory 204 and/or the data storage 222) of previous software identifiers associated with the user account). As indicated in block 324, in some embodiments, the server compute device 110 may determine whether a video capture device of the user (e.g., of the corresponding user compute device 120 used in the authentication attempt) is disabled, such as by querying the user compute device 120 for video data.

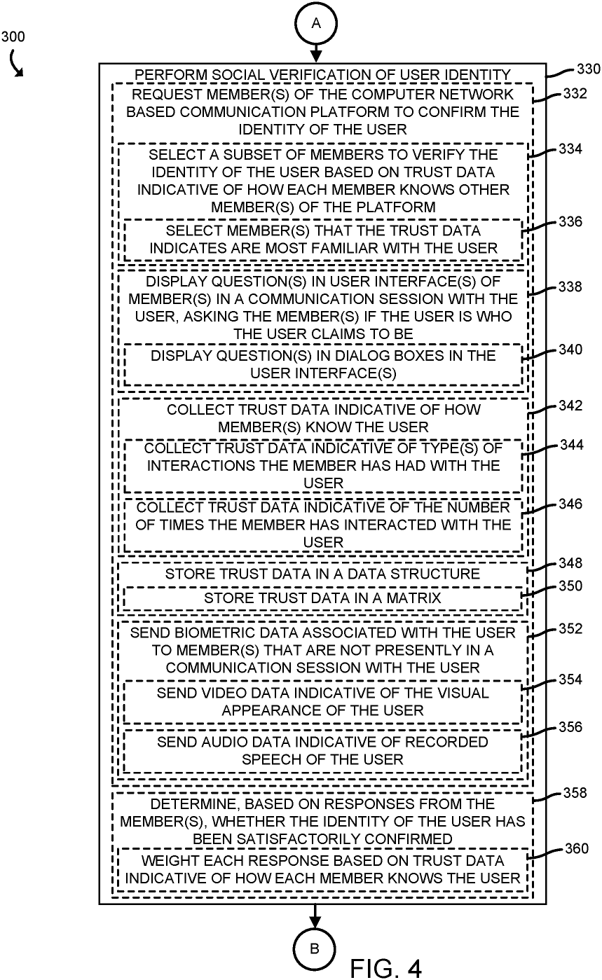

Additionally or alternatively, and as indicated in block 326, the server compute device 110 may determine whether an audio capture device of the user (e.g., of the corresponding user compute device 120 used in the authentication attempt) is disabled, such as by determining whether audio data can be received from the user compute device 120. In block 328, the server compute device 110 determines a subsequent course of action based on whether social verification is warranted. In doing so, the server compute device 110 may determine whether one or a predefined combination of the factors tested in block 316, 318, 320, 322, 324, 326 are present (e.g., that the user is attempting to authenticate from a new geographic location, that a new IP address is being used and the video capture device is disabled, etc.). In response to a determination that social verification is warranted (e.g., that the authentication attempt is sufficiently suspicious), the method 300 advances to block 330 of FIG. 4, in which the server compute device 110 performs social verification of the user identity, based on human analysis of one or more characteristics (e.g., visual appearance, body language, gestures, voice pitch and timbre, speech patterns, voice inflections, or other behavioral or physical characteristics) exhibited by the user.

Referring now to FIG. 4, the server compute device 110, in performing the social verification of the user identity, may request one or more members of the computer network based communication platform (the “platform”) to confirm the identity of the user, as indicated in block 332. In doing so, and as indicated in block 334, the server compute device 110 may select a subset of the members of the platform (e.g., less than all of the members) to verify the identity of the user, based on trust data. The trust data may be embodied as any data indicative of how each member knows other members of the platform (e.g., including the user whose identity is to be verified). In the illustrative embodiment, the server compute device 110 selects a subset of members that the trust data indicates are the most familiar with the user (e.g., by sorting the members based on their familiarity with the user whose identity is to be verified, such as based on the number of times each member has interacted with the user and/or the types of interactions (e.g., in which in-person interactions indicate more familiarity than computer network based interactions, such as video conferences)), as indicated in block 336. In other embodiments, trust data may not yet exist in relation to the user whose identity is to be verified. In that situation, the server compute device 110 may select members to verify the identity of the user based on other criteria (e.g., random selection, geographic proximity to the user, etc.). As indicated in block 338, the server compute device 110 displays (e.g., by sending corresponding instructions to a user compute device 120) one or more questions in a user interface of one or more members (e.g., each member in the selected subset of members) that are in a communication session with the user whose identity is to be verified. The questions, in the illustrative embodiment, ask the one or more members if the user is who the user claims to be (e.g., who the user is logged in as). In doing so, the server compute device 110 may display (e.g., by sending corresponding instructions to a user compute device 120 of a member) the question(s) in one or more dialog boxes in the user interface. In the illustrative embodiment, the dialog boxes do not overlap any video of the user whose identity is to be confirmed (e.g., to enable each member to view the user while answering the question(s)), as indicated in block 340.

Still referring to FIG. 4, the server compute device 110 may collect trust data indicative of how members of the platform know the user (e.g., to establish a set of trust data regarding the members and the user, to supplement existing trust data, etc.), as indicated in block 342. In doing so, and as indicated in block 344, the server compute device 110 may collect trust data indicative of types of interactions the member (e.g., the member being questioned) has had with the user. Additionally, and as indicated in block 346, the server compute device 110 may collect trust data indicative of the number of times the member has interacted with the user. The server compute device 110 may store the trust data in a data structure (e.g., in the memory 204 and/or the data storage 222), as indicated in block 348. In the illustrative embodiment, the server compute device 110 stores the trust data in a matrix (e.g., a two-dimensional structure with columns and rows of elements), as indicated in block 350. In other embodiments, the trust data may be stored in another data structure usable to represent relationships among members, such as a graph of nodes (e.g., each representing a member of the platform) connected with edges (e.g., each representing a level of familiarity with another member).

In some embodiments, the server compute device 110 may send biometric data associated with the user to one or more members of the platform that are not presently in a communication session (e.g., a video conference) with the user whose identity is to be verified, as indicated in block 352. In doing so, the server compute device 110 may send video data indicative of the visual appearance of the user (e.g., video captured from the user compute device 120 of the user as the user participates in a video conference), as indicated in block 354, and/or audio data indicative of recorded speech of the user (e.g., audio data captures from the user compute device 120 of the user as the user participates in the video conference), as indicated in block 356.

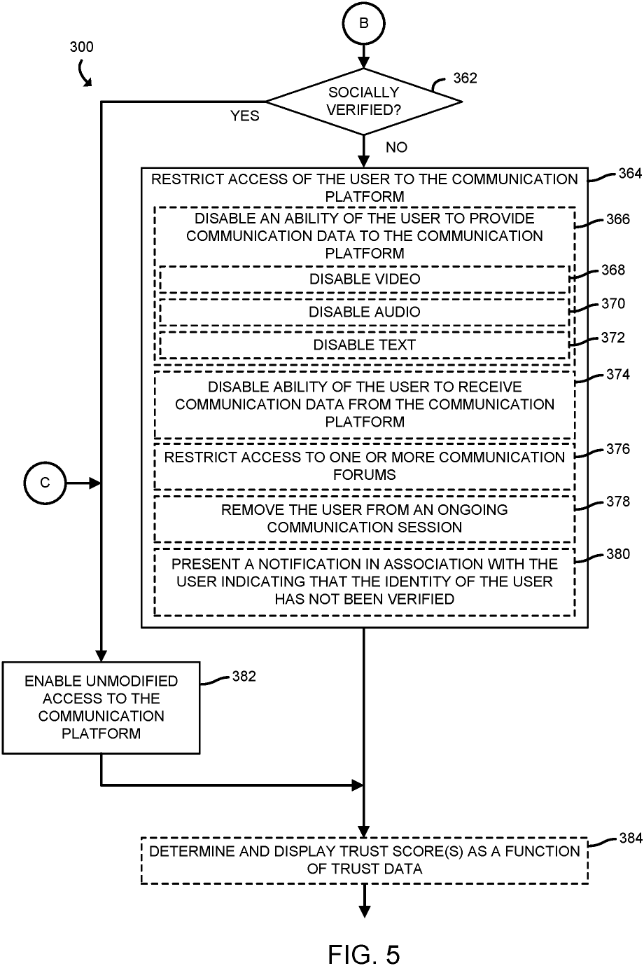

As indicated in block 358, the server compute device 110, in the illustrative embodiment, determines, based on responses from the members, whether the identity of the user has been satisfactorily confirmed (e.g., verified). In doing so, the server compute device 110 may weight each response based on trust data (e.g., already existing trust data and/or trust data collected through the questions presented to the members, such as in block 342) indicative of how each member knows the user, as indicated in block 360. The server compute device 110 may determine that the identity of the user has been satisfactorily confirmed by determining whether a predefined number of confirmations of the user’s identity have been received or a predefined percentage of the members questioned about the identity of the user have confirmed the identity of the user. In the illustrative embodiment, confirmations from members having more familiarity with the user (e.g., as indicated by the trust data) are multiplied by a weight (e.g., a value greater than one) to increase the resulting value of their confirmations to the total set of confirmations received from the members. In some embodiments, confirmations from members having relatively less familiarity from the user are multiplied by corresponding weight (e.g., between 0 and 1) that lessens the value of their confirmation of the user. Similarly, in some embodiments, responses indicating that the user is not who the user claims to be may be weighted based on the trust data. Subsequently, the method 300 advances to block 362 of FIG. 5, in which the server compute device 110 determines the subsequent course of action, based on whether the user identity has been socially verified (e.g., that the identity of the user has been satisfactorily confirmed by member(s) of the platform, as described above).

Referring now to FIG. 5, in response to a determination that the user identity has not been socially verified (e.g., has not been satisfactorily confirmed by member(s) of the platform), the method 300 advances to block 364, in which the server compute device 110, in the illustrative embodiment, restricts access the user to the communication platform. In doing so, and as indicated in block 366, the server compute device 110 may disable an ability of the user to provide communication data to the communication platform. For example, the server compute device 110 may disable (e.g., discard, reject, etc.) video, audio, and/or text data from the user compute device 120 of the unverified user, as indicated in blocks 368, 370, 372. Relatedly, the server compute device 110 may disable the ability of the user to receive communication data (e.g., video, audio, text, etc.) from the communication platform, as indicated in block 374. In some embodiments, the server compute device 110 may restricts the user’s access to one or more communication forums (e.g., message board(s) or other areas in which members of the communication platform may communication), as indicated in block 376. The server compute device 110 may additionally or alternatively remove the user from an ongoing communication session (e.g., a video conference), as indicated in block 378. The server compute device 110 may, in some embodiments, also present a notification (e.g., an icon, a message, etc. on the user interfaces of other members of the platform) in association with the user (e.g., next to the user’s name or graphical representation of the user), indicating that the identity of the user has not been verified, as indicated in block 380.

Referring back to block 362, if the user’s identity has been socially verified, or, if in block 328 of FIG. 3, the server compute device 110 determines that social verification of the user identity is not warranted, the method 300 advances to block 382 of FIG. 5, in which the server compute device 110 enables unmodified access to the communication platform (e.g., without imposing any of the restrictions or modifications from block 364). As indicated in block 384, the server compute device 110 may also determine and display trust scores associated with one or more users of the platform. The server compute device 110 may determine the trust score for a given user as a function of trust data (e.g., stored in the data structure of block 348). In some embodiments, the trust score increases as the number of members who are familiar with the user increases. Additionally, the trust score may increase when the familiarity of one or more members with the user increases. That is, in some embodiments, if a given member has frequent interactions with the user, the user’s trust score may increase solely from those interactions, regardless of whether the total number of members familiar with the user increase. The server compute device 110 may present (e.g., near the user’s name or other representation of the user) the trust score as an icon, a number, or other visual indication of the level of familiarity of other members of the platform with the user. While the operations in the method 300 are shown and described in a particular order, it should be understood that the operations could be performed in a different order or concurrently.

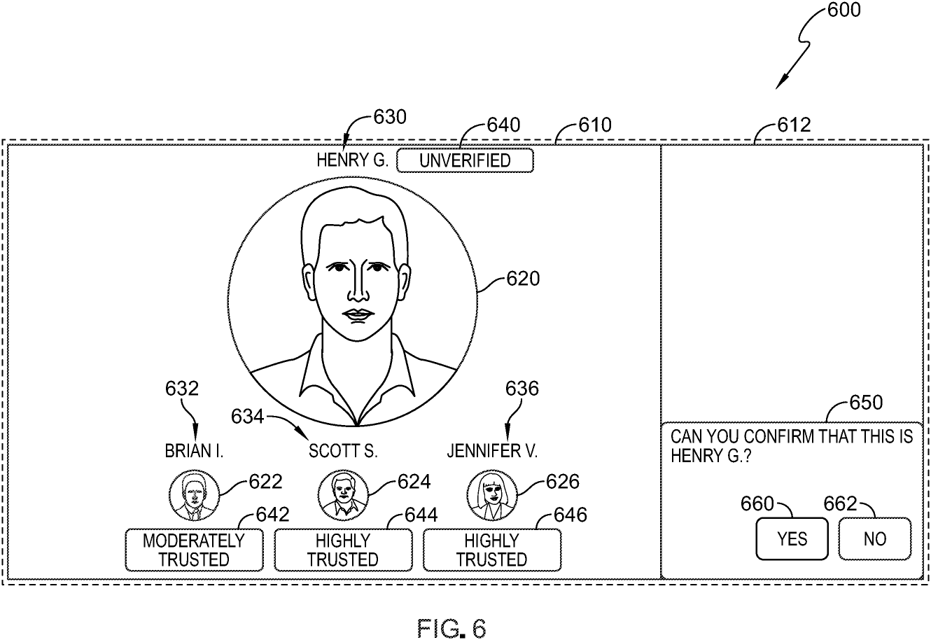

Referring now to FIG. 6, a user interface 600 produced by the system 100 (e.g., displayed by a user compute device 120 based on instructions and data sent from the server compute device 110) incudes, in the illustrative embodiment, two sections 610, 612 of user interface elements associated with an ongoing video conference. In the section 610, graphical representations 620, 622, 624, 626 (e.g., video frames, placeholder images, such as silhouettes, avatars, etc.) of participants (e.g., users of the system 100) in the video conference are positioned near user identifiers 630, 632, 634, 636 (e.g., user names) of the participants. Near the user identifier 630 for a user (e.g., participant) that is presently speaking is a visual indication 640 that the identity of the user has not been verified. In the illustrative embodiment, the visual indication 640 includes the text “UNVERIFIED”. The visual indication, in other embodiments, may additionally or alternatively include other text and/or graphics to indicate that the identity of the user has not been verified (e.g., that the system 100 determined that social verification of the user’s identity was warranted and that social verification of the user’s identity has not been obtained). Additionally, in section 610, the user interface 600 includes visual indications of trust scores 642, 644, 646 (e.g., from block 384 of FIG. 5) for each of the other users participating in the video conference. While the visual indication 642 includes the text “MODERATELY TRUSTED” and the visual indications 644 and 646 include the text “HIGHLY TRUSTED”, in other embodiments, the visual indications may additionally or alternatively include other text or graphics to indicate a corresponding trust score for each user.

Still referring to FIG. 6, section 612 of the user interface 600 includes a dialog box 650 (e.g., a temporary window created to retrieve user input) with a prompt for the present user (e.g., a member of the platform viewing the user interface 600 and participating in the video conference) to respond with an indication of whether the present user can confirm that a particular unverified user is who the unverified user claims to be (e.g., that the person speaking in the video conference is Henry G.). The dialog box 650 includes a yes button 660 and a no button 662. In response to detecting selection of the yes button, 660, the user compute device 120 sends a corresponding communication to the system 100 (e.g., to the server compute device 110) indicating that the present user can confirm that the unverified user is Henry G. Conversely, if the user compute device 120 instead determines that the no button 662 was selected, the user compute device 120 sends a communication to the system 100 (e.g., to the server compute device 110) indicating that the present user cannot confirm that the unverified user is Henry G.

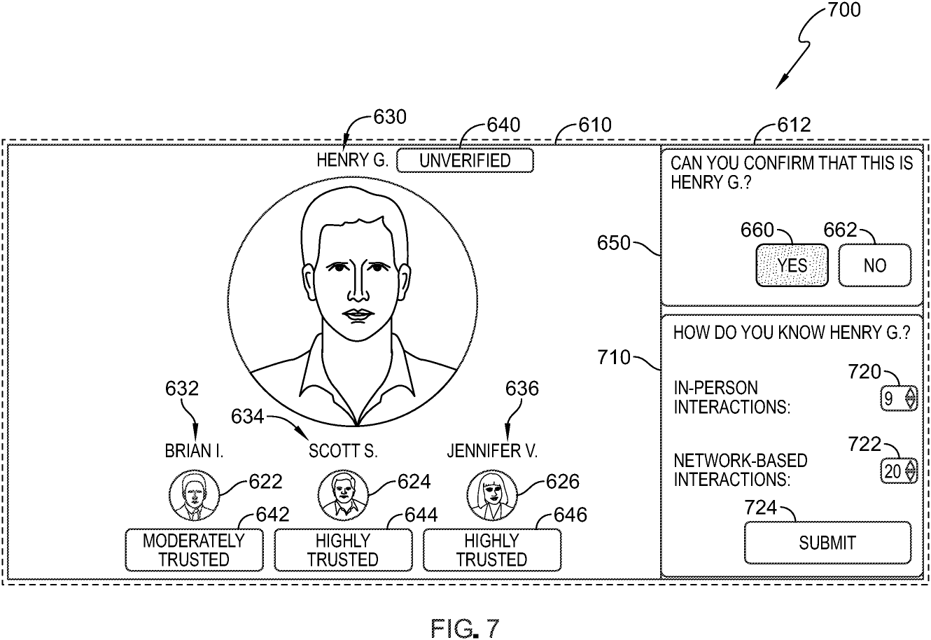

Referring now to FIG. 7, in response to receiving a communication indicating that the present user (e.g., member of the platform) can confirm the identity of the unverified user (e.g., that the unverified user is Henry G.), the system 100 (e.g., the server compute device 110) causes the user compute device 120 to display a subsequent user interface 700 requesting information about how the present user knows the unverified user. Specifically, in the illustrative user interface 700, the section 612 includes a dialog box 710 that has displaced the dialog box 650, with the follow up question asking how the present user knows the unverified user (e.g., “How do you know Henry G.?”). To enable the present user to answer the question, the dialog box 710 includes a sub-question prompting the present user to indicate the number of in-person interactions the present user has had with the unverified user and another sub-question prompting the present user to indicate the number of network-based interactions (e.g., via a computer network, such as the network 140) the present user has had with the unverified user. Each sub-question is associated with a corresponding user interface element 720, 722 that enables the user to enter a numeric value. Additionally, the dialog box 710 includes a submit button 724. In response to detecting that the submit button 724 has been selected, the user compute device 120 sends the numeric values indicated in the user interface elements 720, 722 to the system 100 (e.g., to the server compute device 110) for use in determining whether the unverified user’s identity has been satisfactorily verified. In doing so, the server compute device 110 may recalculate one or more trust scores and weight the response from the present user based on the present user’s trust score, as described with reference to the method 300.

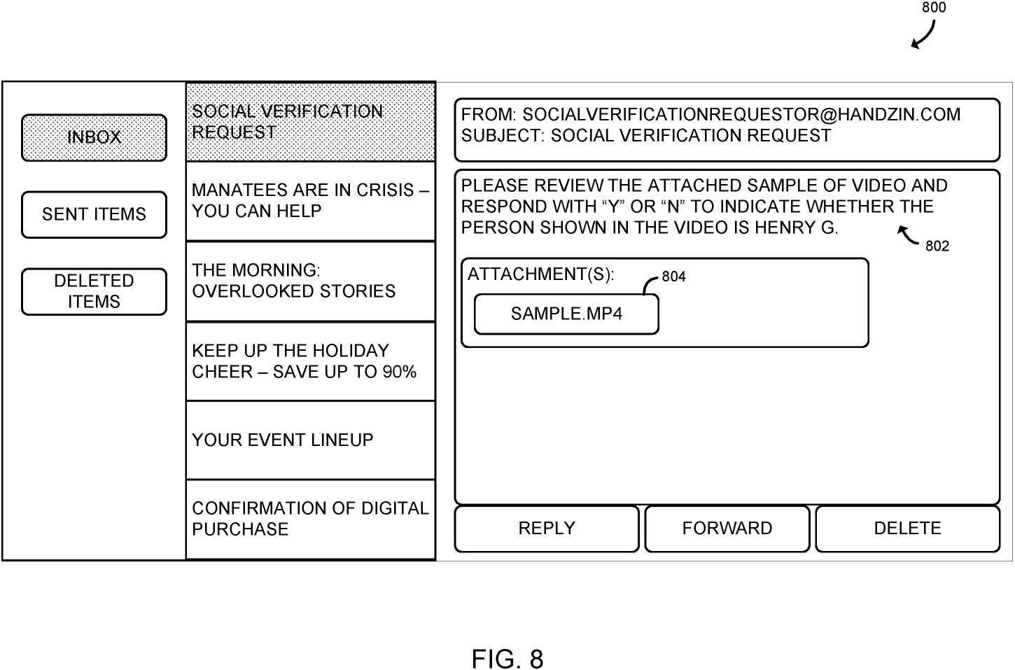

Referring now to FIG. 8, the system 100 (e.g., the server compute device 110) may send a request to a member of the platform who is not presently in a communication session with an unverified user, requesting the member to verify the identity of the user. As indicated in the user interface 800 (e.g., an email client), the user compute device 120 of a member of the platform has received an email from the server compute device 110. The email includes text 802 prompting the member to review an attached sample 804 (e.g., recording) of video and respond with an indication (e.g., “Y” or “N”) to indicate whether the person shown in the video is who the user claims to be (e.g., Henry G.). In the illustrative embodiment, the member may select the sample 804, observe the sample 804, and send a responsive email with a “Y” or “N” to indicate whether the member believes that the user represented in the sample 804 is indeed who the user claims to be. In response, the server compute device 110 may assigned a weight to the indication received from the user compute device 120 of the member, based on trust data indicative of how well the member knows the user (e.g., Henry G.), as described with reference to block 358 and 360 of FIG. 4. While communication via email is described herein as an example communication between the server compute device 110 and a member who is not presently in a communication session with the unverified user, in other embodiments, other communication channels (e.g., text message, a telephone call, etc.) may be used as an alternative or in addition to email.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a device comprising circuitry configured to determine whether a compute device of a user has requested to join a communication session hosted on a computer network based communication platform; perform, in response to a determination that the compute device of the user has requested to join the communication session and based on one or more authentication credentials of the user, a primary verification operation to verify an identity of the user; determine, after performance of the primary verification operation, whether a social verification of the identity of the user, based on a human analysis of one or more exhibited characteristics of the user, is warranted; request, in response to a determination that social verification of the identity of the user is warranted and from a member of the communication platform, confirmation of the identity of the user; and weight the confirmation of the identity of the user as a function of trust data indicative of how the member knows the user.

Example 2 includes the subject matter of Example 1, and wherein to determine, after performance of the primary verification operation, whether a social verification of the identity of the user is warranted comprises to determine whether the compute device of the user has previously been used with the communication platform; and determine, in response to a determination that the compute device of the user has not previously been used with the communication platform, that social verification of the identity of the user is warranted.

Example 3 includes the subject matter of any of Examples 1 and 2, and wherein to determine, after performance of the primary verification operation, whether a social verification of the identity of the user is warranted comprises to determine whether the compute device of the user has requested to join the communication session from a geographic region that the user has not previously utilized the communication platform from; and determine, in response to a determination that the user has not previously utilized the communication platform from the geographic region, that social verification of the identity of the user is warranted.

Example 4 includes the subject matter of any of Examples 1-3, and wherein to determine, after performance of the primary verification operation, whether a social verification of the identity of the user is warranted comprises to determine whether a video capture device of the compute device of the user is disabled; and determine, in response to a determination that the video capture device is disabled, that social verification of the identity of the user is warranted.

Example 5 includes the subject matter of any of Examples 1-4, and wherein to determine, after performance of the primary verification operation, whether a social verification of the identity of the user is warranted comprises to determine whether an audio capture device of the compute device of the user is disabled; and determine, in response to a determination that the audio capture device is disabled, that social verification of the identity of the user is warranted.

Example 6 includes the subject matter of any of Examples 1-5, and wherein to request, from a member of the communication platform, confirmation of the identity of the user comprises to cause a dialog box to be displayed by a compute device of the member that requests data indicative of whether the member can confirm the identity of the user.

Example 7 includes the subject matter of any of Examples 1-6, and wherein the circuitry is further configured to collect, from a member of the communication platform, trust data indicative of how the member knows the user.

Example 8 includes the subject matter of any of Examples 1-7, and wherein to collect, from the member, trust data indicative of how the member knows the user comprises to collect trust data indicative of one or more types of interactions that the member has had with the user and trust data indicative of a number of times that the member has interacted with the user.

Example 9 includes the subject matter of any of Examples 1-8, and wherein the circuitry is further to store, in a data structure, trust data indicative of how each member of the communication platform knows one or more other members of the communication platform.

Example 10 includes the subject matter of any of Examples 1-9, and wherein the circuitry is further configured to determine, as a function of the trust data indicative of how each member knows one or more other members of the communication platform, a trust score for each member of the communication platform; and cause a visual indication of a trust score associated with a member to be displayed to one or more other members of the communication platform.

Example 11 includes the subject matter of any of Examples 1-10, and wherein to request confirmation of the identity of the user comprises to send a sample of audio or video of the user to the member for review.

Example 12 includes the subject matter of any of Examples 1-11, and wherein the circuitry is further configured to restrict, in response to a determination that the identity of the user was not satisfactorily confirmed through social verification, access of the user to the communication platform.

Example 13 includes the subject matter of any of Examples 1-12, and wherein the circuitry is further configured to select, from a set of multiple members of the communication platform and as a function of trust data indicative of how each member knows one or more other members of the communication platform, a subset of one or more members from whom to request confirmation of the identification of the user.

Example 14 includes a method comprising determining, by a compute device, whether a compute device of a user has requested to join a communication session hosted on a computer network based communication platform; performing, by the compute device and in response to a determination that the compute device of the user has requested to join the communication session and based on one or more authentication credentials of the user, a primary verification operation to verify an identity of the user; determining, by the compute device and after performance of the primary verification operation, whether a social verification of the identity of the user, based on a human analysis of one or more exhibited characteristics of the user, is warranted; requesting, by the compute device and in response to a determination that social verification of the identity of the user is warranted and from a member of the communication platform, confirmation of the identity of the user; and weighting, by the compute device, the confirmation of the identity of the user as a function of trust data indicative of how the member knows the user.

Example 15 includes the subject matter of Example 14, and wherein determining, after performance of the primary verification operation, whether a social verification of the identity of the user is warranted comprises determining whether the compute device of the user has previously been used with the communication platform; and determining, in response to a determination that the compute device of the user has not previously been used with the communication platform, that social verification of the identity of the user is warranted.

Example 16 includes the subject matter of any of Examples 14 and 15, and wherein determining, after performance of the primary verification operation, whether a social verification of the identity of the user is warranted comprises determining whether the compute device of the user has requested to join the communication session from a geographic region that the user has not previously utilized the communication platform from; and determining, in response to a determination that the user has not previously utilized the communication platform from the geographic region, that social verification of the identity of the user is warranted.

Example 17 includes the subject matter of any of Examples 14-16, and wherein determining, after performance of the primary verification operation, whether a social verification of the identity of the user is warranted comprises determining whether a video capture device of the compute device of the user is disabled; and determining, in response to a determination that the video capture device is disabled, that social verification of the identity of the user is warranted.

Example 18 includes the subject matter of any of Examples 14-17, and wherein determining, after performance of the primary verification operation, whether a social verification of the identity of the user is warranted comprises determining whether an audio capture device of the compute device of the user is disabled; and determining, in response to a determination that the audio capture device is disabled, that social verification of the identity of the user is warranted.

Example 19 includes the subject matter of any of Examples 14-18, and wherein requesting, from a member of the communication platform, confirmation of the identity of the user comprises causing a dialog box to be displayed by a compute device of the member that requests data indicative of whether the member can confirm the identity of the user.

Example 20 includes the subject matter of any of Examples 14-19, and further including collecting, by the compute device and from a member of the communication platform, trust data indicative of how the member knows the user.

Example 21 includes the subject matter of any of Examples 14-20, and wherein collecting, from the member, trust data indicative of how the member knows the user comprises collecting trust data indicative of one or more types of interactions that the member has had with the user and trust data indicative of a number of times that the member has interacted with the user.

Example 22 includes the subject matter of any of Examples 14-21, and further including storing, by the compute device and in a data structure, trust data indicative of how each member of the communication platform knows one or more other members of the communication platform.

Example 23 includes the subject matter of any of Examples 14-22, and further including determining, by the compute device and as a function of the trust data indicative of how each member knows one or more other members of the communication platform, a trust score for each member of the communication platform; and causing, by the compute device, a visual indication of a trust score associated with a member to be displayed to one or more other members of the communication platform.

Example 24 includes the subject matter of any of Examples 14-23, and wherein requesting confirmation of the identity of the user comprises sending a sample of audio or video of the user to the member for review.

Example 25 includes the subject matter of any of Examples 14-24, and further including restricting, by the compute device and in response to a determination that the identity of the user was not satisfactorily confirmed through social verification, access of the user to the communication platform.

Example 26 includes the subject matter of any of Examples 14-25, and further including selecting, by the compute device and from a set of multiple members of the communication platform and as a function of trust data indicative of how each member knows one or more other members of the communication platform, a subset of one or more members from whom to request confirmation of the identification of the user.

Example 27 includes one or more machine-readable storage media comprising a plurality of instructions stored thereon that, in response to being executed, cause a device to determine whether a compute device of a user has requested to join a communication session hosted on a computer network based communication platform; perform, in response to a determination that the compute device of the user has requested to join the communication session and based on one or more authentication credentials of the user, a primary verification operation to verify an identity of the user; determine, after performance of the primary verification operation, whether a social verification of the identity of the user, based on a human analysis of one or more exhibited characteristics of the user, is warranted; request, in response to a determination that social verification of the identity of the user is warranted and from a member of the communication platform, confirmation of the identity of the user; and weight the confirmation of the identity of the user as a function of trust data indicative of how the member knows the user.

Example 28 includes the subject matter of Example 27, and wherein to determine, after performance of the primary verification operation, whether a social verification of the identity of the user is warranted comprises to determine whether the compute device of the user has previously been used with the communication platform; and determine, in response to a determination that the compute device of the user has not previously been used with the communication platform, that social verification of the identity of the user is warranted.

Example 29 includes the subject matter of any of Examples 27 and 28, and wherein to determine, after performance of the primary verification operation, whether a social verification of the identity of the user is warranted comprises to determine whether the compute device of the user has requested to join the communication session from a geographic region that the user has not previously utilized the communication platform from; and determine, in response to a determination that the user has not previously utilized the communication platform from the geographic region, that social verification of the identity of the user is warranted.

Example 30 includes the subject matter of any of Examples 27-29, and wherein to determine, after performance of the primary verification operation, whether a social verification of the identity of the user is warranted comprises to determine whether a video capture device of the compute device of the user is disabled; and determine, in response to a determination that the video capture device is disabled, that social verification of the identity of the user is warranted.

Example 31 includes the subject matter of any of Examples 27-30, and wherein to determine, after performance of the primary verification operation, whether a social verification of the identity of the user is warranted comprises to determine whether an audio capture device of the compute device of the user is disabled; and determine, in response to a determination that the audio capture device is disabled, that social verification of the identity of the user is warranted.

Example 32 includes the subject matter of any of Examples 27-31, and wherein to request, from a member of the communication platform, confirmation of the identity of the user comprises to cause a dialog box to be displayed by a compute device of the member that requests data indicative of whether the member can confirm the identity of the user.

Example 33 includes the subject matter of any of Examples 27-32, and wherein the instructions further cause the compute device to collect, from a member of the communication platform, trust data indicative of how the member knows the user.

Example 34 includes the subject matter of any of Examples 27-33, and wherein to collect, from the member, trust data indicative of how the member knows the user comprises to collect trust data indicative of one or more types of interactions that the member has had with the user and trust data indicative of a number of times that the member has interacted with the user.

Example 35 includes the subject matter of any of Examples 27-34, and wherein the instructions further cause the device to store, in a data structure, trust data indicative of how each member of the communication platform knows one or more other members of the communication platform.

Example 36 includes the subject matter of any of Examples 27-35, and wherein the instructions further cause the device to determine, as a function of the trust data indicative of how each member knows one or more other members of the communication platform, a trust score for each member of the communication platform; and cause a visual indication of a trust score associated with a member to be displayed to one or more other members of the communication platform.

Example 37 includes the subject matter of any of Examples 27-36, and wherein to request confirmation of the identity of the user comprises to send a sample of audio or video of the user to the member for review.

Example 38 includes the subject matter of any of Examples 27-37, and wherein the instructions further cause the device to restrict, in response to a determination that the identity of the user was not satisfactorily confirmed through social verification, access of the user to the communication platform.

Example 39 includes the subject matter of any of Examples 27-38, and wherein the instructions further cause the device to select, from a set of multiple members of the communication platform and as a function of trust data indicative of how each member knows one or more other members of the communication platform, a subset of one or more members from whom to request confirmation of the identification of the user.

1. A device comprising:
circuitry configured to:
determine whether a compute device of a user has requested to join a communication session hosted on a computer network based communication platform;
perform, in response to a determination that the compute device of the user has requested to join the communication session and based on one or more authentication credentials of the user, a primary verification operation to verify an identity of the user;
determine, after performance of the primary verification operation, whether a social verification of the identity of the user, based on a human analysis of one or more exhibited characteristics of the user, is warranted;
request, in response to a determination that social verification of the identity of the user is warranted and from a member of the communication platform, confirmation of the identity of the user; and
weight the confirmation of the identity of the user as a function of trust data indicative of how the member knows the user.

2. The device of claim 1, wherein to determine, after performance of the primary verification operation, whether a social verification of the identity of the user is warranted comprises to:
determine whether the compute device of the user has previously been used with the communication platform; and
determine, in response to a determination that the compute device of the user has not previously been used with the communication platform, that social verification of the identity of the user is warranted.

3. The device of claim 1, wherein to determine, after performance of the primary verification operation, whether a social verification of the identity of the user is warranted comprises to:
determine whether the compute device of the user has requested to join the communication session from a geographic region that the user has not previously utilized the communication platform from; and
determine, in response to a determination that the user has not previously utilized the communication platform from the geographic region, that social verification of the identity of the user is warranted.

4. The device of claim 1, wherein to determine, after performance of the primary verification operation, whether a social verification of the identity of the user is warranted comprises to:
determine whether a video capture device of the compute device of the user is disabled; and
determine, in response to a determination that the video capture device is disabled, that social verification of the identity of the user is warranted.

5. The device of claim 1, wherein to determine, after performance of the primary verification operation, whether a social verification of the identity of the user is warranted comprises to:
determine whether an audio capture device of the compute device of the user is disabled; and
determine, in response to a determination that the audio capture device is disabled, that social verification of the identity of the user is warranted.

6. The device of claim 1, wherein to request, from a member of the communication platform, confirmation of the identity of the user comprises to cause a dialog box to be displayed by a compute device of the member that requests data indicative of whether the member can confirm the identity of the user.

7. The device of claim 1, wherein the circuitry is further configured to collect, from a member of the communication platform, trust data indicative of how the member knows the user.

8. The device of claim 7, wherein to collect, from the member, trust data indicative of how the member knows the user comprises to collect trust data indicative of one or more types of interactions that the member has had with the user and trust data indicative of a number of times that the member has interacted with the user.

9. The device of claim 7, wherein the circuitry is further to store, in a data structure, trust data indicative of how each member of the communication platform knows one or more other members of the communication platform.

10. The device of claim 8, wherein the circuitry is further configured to:
determine, as a function of the trust data indicative of how each member knows one or more other members of the communication platform, a trust score for each member of the communication platform; and
cause a visual indication of a trust score associated with a member to be displayed to one or more other members of the communication platform.

11. The device of claim 1, wherein to request confirmation of the identity of the user comprises to send a sample of audio or video of the user to the member for review.

12. The device of claim 1, wherein the circuitry is further configured to restrict, in response to a determination that the identity of the user was not satisfactorily confirmed through social verification, access of the user to the communication platform.

13. The device of claim 1, wherein the circuitry is further configured to select, from a set of multiple members of the communication platform and as a function of trust data indicative of how each member knows one or more other members of the communication platform, a subset of one or more members from whom to request confirmation of the identification of the user.

14. A method comprising:
determining, by a compute device, whether a compute device of a user has requested to join a communication session hosted on a computer network based communication platform;
performing, by the compute device and in response to a determination that the compute device of the user has requested to join the communication session and based on one or more authentication credentials of the user, a primary verification operation to verify an identity of the user;
determining, by the compute device and after performance of the primary verification operation, whether a social verification of the identity of the user, based on a human analysis of one or more exhibited characteristics of the user, is warranted;
requesting, by the compute device and in response to a determination that social verification of the identity of the user is warranted and from a member of the communication platform, confirmation of the identity of the user; and
weighting, by the compute device, the confirmation of the identity of the user as a function of trust data indicative of how the member knows the user.

15. The method of claim 14, wherein determining, after performance of the primary verification operation, whether a social verification of the identity of the user is warranted comprises:
determining whether the compute device of the user has previously been used with the communication platform; and
determining, in response to a determination that the compute device of the user has not previously been used with the communication platform, that social verification of the identity of the user is warranted.

16. The method of claim 14, wherein determining, after performance of the primary verification operation, whether a social verification of the identity of the user is warranted comprises:
determining whether the compute device of the user has requested to join the communication session from a geographic region that the user has not previously utilized the communication platform from; and
determining, in response to a determination that the user has not previously utilized the communication platform from the geographic region, that social verification of the identity of the user is warranted.

17. The method of claim 14, wherein determining, after performance of the primary verification operation, whether a social verification of the identity of the user is warranted comprises:
determining whether a video capture device of the compute device of the user is disabled; and
determining, in response to a determination that the video capture device is disabled, that social verification of the identity of the user is warranted.

18. The method of claim 14, wherein determining, after performance of the primary verification operation, whether a social verification of the identity of the user is warranted comprises:
determining whether an audio capture device of the compute device of the user is disabled; and
determining, in response to a determination that the audio capture device is disabled, that social verification of the identity of the user is warranted.

19. The method of claim 14, wherein requesting, from a member of the communication platform, confirmation of the identity of the user comprises causing a dialog box to be displayed by a compute device of the member that requests data indicative of whether the member can confirm the identity of the user.

20. One or more machine-readable storage media comprising a plurality of instructions stored thereon that, in response to being executed, cause a device to:
determine whether a compute device of a user has requested to join a communication session hosted on a computer network based communication platform;
perform, in response to a determination that the compute device of the user has requested to join the communication session and based on one or more authentication credentials of the user, a primary verification operation to verify an identity of the user;
determine, after performance of the primary verification operation, whether a social verification of the identity of the user, based on a human analysis of one or more exhibited characteristics of the user, is warranted;
request, in response to a determination that social verification of the identity of the user is warranted and from a member of the communication platform, confirmation of the identity of the user; and
weight the confirmation of the identity of the user as a function of trust data indicative of how the member knows the user.
